(19) United States
(12) Patent Application Publication
(10) Pub. No.: US 2018/0313134 A1
(43) Pub. Date: Nov. 1, 2018

(54) METHOD FOR ACTIVATING AT LEAST ONE FUNCTIONAL DEVICE OF A VEHICLE

(71) Applicant: Hella GmbH & Co. KGaA, Lippstadt (DE)

(72) Inventors: Thomas NIEMANN, Delmenhorst (DE); Christian JURGENS, STUTTGART (DE); Patrick FUCHS, Leongberg (DE); Hauke Baumgartel, Delmenhorst (DE)

(21) Appl. No.: 15/965,677

(22) Filed: Apr. 27, 2018

(30) Foreign Application Priority Data
Apr. 27, 2017 (DE) 10 2017 109 011.8

(51) Int. Cl. E05F 15/75

(52) U.S. Cl. CPC E05F 15/75; B62D 25/10

(57) ABSTRACT

In a method for activating at least one functional device of a vehicle, it is provided as essential to the invention that at least one structure-borne sound signal caused by a vehicle user on the vehicle shell of the vehicle is detected with at least one structure-borne sound sensor, that the structure-borne sound signal is analysed by means of an evaluation device for the presence of a specific signal pattern, that a specific functional device of the vehicle is assigned to the signal pattern and that on detecting the specific signal pattern a control signal is sent to the functional device assigned to the signal pattern.

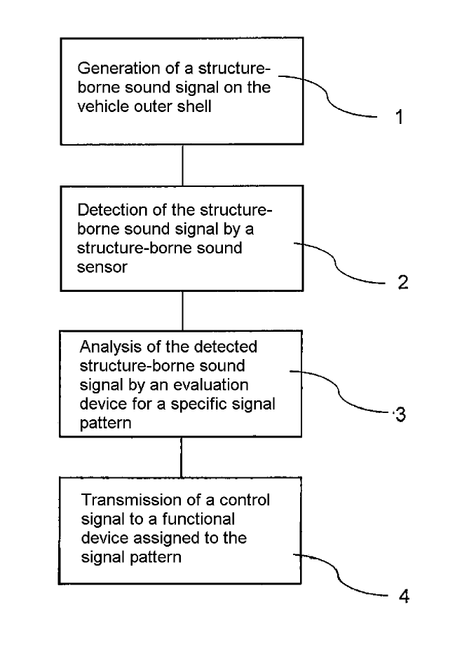

The invention concerns a method for activating at least one functional device of a vehicle and a vehicle with structure-borne sound conducting structure-borne sound sensors connected to the outer shell, having at least one evaluation device for evaluating structure-borne sound signals and with at least one control unit for activating at least one functional device of the vehicle.

Vehicles have a multiplicity of functional devices such as for example lighting devices, acoustic devices or also actuators such as electric window winders or drive devices for the tailgate. These functional devices contribute significantly to the comfort of the vehicle user in that the tailgate, for example, can open itself independently, without this having to be done by hand. For many functions such as, for example, the automatic opening of the tailgate, buttons are provided on the vehicle which have to be operated, for example, by touching them. These buttons are often heavily exposed to environmental factors such as cold, frost and dirt and influence, in addition, the design of the components. For example the buttons must be integrated into the tailgate and thus limit the freedom of design. Further, buttons that are provided are often only assigned one vehicle function; a single button with multiple functions is generally not provided. Furthermore, the installation, especially the wiring, of buttons distributed over the whole vehicle is complicated and thus cost-intensive and time consuming in terms of assembly.

The aim of the invention is to propose a method for activating functional devices of a vehicle in which the arrangement of extra buttons for this purpose can be done away with.

This aim is achieved by a method with the characteristics of patent claim 1 as well as by a vehicle with the characteristics of patent claim 9. Advantageous further developments and embodiments are specified in the sub-claims.

In a method for activating at least one functional device of a vehicle, it is provided as essential to the invention that at least one structure-borne sound signal caused by a vehicle user on the vehicle shell of the vehicle is detected with at least one structure-borne sound sensor, that the structure-borne sound signal is analysed by means of an evaluation device for the presence of a specific signal pattern, that a specific functional device of the vehicle is assigned to the signal pattern and that on detecting the specific signal pattern a control signal is sent to the functional device assigned to the signal pattern.

Structure-borne sound sensors can be arranged on the outer shell of the vehicle, in particular on the inside of the outer shell of a vehicle, thus comprising a structure-borne sound conducting connection to the outer shell of the vehicle. Structure-borne sound sensors are often used in vehicles to detect, for example, contact events, in particular damaging events, on the outer shell of the vehicle. In order to operate a functional device of the vehicle, a structure-borne sound signal can be generated on the outer shell of the vehicle by the vehicle user. The structure-borne sound signal can in particular be generated by tapping on the outer shell of the vehicle from the outside. The structure-borne sound signal generated by the vehicle user is detected by at least one structure-borne sound sensor and evaluated by means of an evaluation device. The structure-borne sound signal can in particular be analysed for the presence of a specific signal pattern. In this connection in particular, the structure-borne sound signal is analysed for a specific tapping sequence, i.e. a particular tapping rhythm. Each functional device which can be activated by a tapping signal can thus be assigned a signal pattern of its own. The assigning of different signal patterns to different functional devices makes it possible to determine which functional device is meant to be activated. By way of example, a tapping rhythm can be assigned to a drive device of a window, so that by generating the specific tapping rhythm on the outer shell a vehicle window can be opened. Similarly, for example, the tailgate can be opened or the hazard lights switched on. The signal pattern assigned to each functional device can be stored, for example, in a control unit. By using structure-borne sound sensors for detecting vehicle user commands, a possibility is created by simple means to do away with the use of extra buttons provided specifically for this purpose.

In a further development of the method the functional device involves a drive device of a closure element of a vehicle opening, in particular a vehicle door and/or a vehicle window. In particular the vehicle windows and the side doors or the tailgate of the vehicle can be assigned different signal patterns, in particular specific tapping patterns. Thus for example the sunroof, or also the tailgate, can be opened by generating a tapping pattern on the outer shell.

In a further development of the method the functional device involves at least one drive device for the front bonnet and/or the tailgate and/or the charge point cover and/or the fuel cap. For example, by generating different signal patterns the front bonnet, the tailgate or the charge point cover of the energy supply interface of the vehicle for example can be opened. Thus for example at a petrol station the fuel cap can be automatically opened by the vehicle user by tapping on the outer shell of the vehicle. Similarly, the tailgate can be opened by a simple tapping pattern on the vehicle shell. In a further development of the invention each closure element to be activated is assigned at least one structure-borne sound sensor. On the detection of a structure-borne sound signal by the assigned structure-borne sound sensor a control signal is sent to the drive device of the closure element so that an at least partial opening or closing of the closure element is initiated. For example, structure-borne sound sensors arranged in the roof can be assigned to a roof window, or structure-borne sound sensors arranged in the tailgate can be assigned to the tailgate. By generating a structure-borne sound signal, in particular a tapping pattern, in the sensing area of the assigned structure-borne sound sensors, so for example on the roof or the tailgate, the opening of the roof window or the tailgate can be initiated. Thus as well as the assignment of the functional device to a specific tapping pattern, a local assignment of the structure-borne sound sensors to the functional devices is also established, so that unwanted activations of the functional devices are further minimised.

In a further development of the invention a number of structure-borne sound sensors are assigned to one closure element. For example a number of structure-borne sound sensors can be arranged in the closure elements, for example the doors or the tailgate, in order to detect structure-borne sound signals. For example several structure-borne sound sensors can also be arranged in the roof, in order to reliably provide a reliable detection of the structure-borne sound signals generated.

In a further development of the invention at least one signal pattern which is assigned to a specific functional device can be individually determined. The signal patterns that are assigned to the different functional devices of the vehicle can be individually determined, for example by the vehicle user. For example a specific tapping pattern for opening the tailgate can be determined by the vehicle user. Thus more or less complicated tapping patterns can be determined according to the preferences of the vehicle user.

In a further development of the method the signal patterns of the structure-borne sound signals to be detected can be generated by a tapping sequence made by a vehicle user on the outer shell of the vehicle. Generating a tapping sequence on the outer shell of the vehicle provides a particularly simple method of generating an actuating signal for a functional device of the vehicle.

In a further development of the method the intensity and/or the number and/or the chronological sequence of the tapping contacts in a signal pattern is detected in the evaluation device. A signal pattern can be characterised in particular by the intensity, so in particular by the size of the amplitudes of the structure-borne sound signal, the number of peaks which are generated by the tapping contacts, and by the chronological sequence of the peaks which stem from the tapping contacts. A signal pattern can be clearly identified for example by the number and the chronological sequence of the peaks in a particular time section of the signal. These parameters can be stored for example in a control unit of the vehicle. These parameters characterise different signal patterns which can be assigned to different functional devices of the vehicle.

Furthermore, the invention concerns a vehicle with structure-borne sound conducting structure-borne sound sensors connected with the outer shell of the vehicle, with at least one evaluation device for evaluating structure-borne sound signals and at least one control unit for activating at least one functional device of the vehicle, in which it is essential to the invention that the structure-borne sound sensors are designed to detect at least one structure-borne sound signal in the form of a tapping pattern on the outer shell of the vehicle, that the evaluation device is designed to analyse the detected structure-borne sound signal for the presence of at least one specific signal pattern, and that the evaluation device is connected in a signal-conducting manner for control purposes to at least one functional device of the vehicle via a control unit.

Vehicles can have structure-borne sound sensors for detecting accident events or contact events with the outer shell of the vehicle. For this purpose the structure-borne sound sensors can be arranged on the outer shell of the vehicle, in particular on the inside of the outer shell, and thus connected to the vehicle shell in a structure-borne sound conducting manner. The structure-borne sound sensors are designed to detect structure-borne sound signals which are generated by tapping patterns on the outer shell of the vehicle for example by the vehicle user. The tapping patterns generated on the outer shell are detected by the structure-borne sound sensors and forwarded to an evaluation device. The evaluation device is designed so that the detected structure-borne sound signals can be analysed for the presence of a specific signal pattern. Different tapping patterns or signal patterns can be assigned to different functional devices of the vehicle, such as for example the drive devices of closure elements or also signal emitting devices. On the detection by an evaluation device of a specific signal pattern, a control signal can be sent via a control unit to a functional device to which that signal pattern is assigned. For this purpose the evaluation device comprises a signal conducting connection with a control unit and thus with the functional device.

In a further development of the invention, the vehicle comprises at least one drive device for driving at least one closure device, in particular of a vehicle door and/or of a vehicle window and each closure device is assigned at least one structure-borne sound sensor via a structure-borne sound conducting connection. The closure devices can involve vehicle doors, in particular a tailgate, and window areas, in particular a roof window. For example structure-borne sound sensors can be arranged in the vehicle doors or otherwise connected with the closure devices in a structure-borne sound conducting manner. On the detection of a structure-borne sound signal by a structure-borne sound sensor assigned to a closure device, following the evaluation of the structure-borne sound signal, the actuation of the closure device can be initiated. For example, if the correct assigned signal pattern is detected, the opening of the tailgate can be initiated by tapping on the tailgate.

The invention is explained further below, by means of an exemplary embodiment depicted in the drawing.

The Sole FIGURE shows a schematic sequence of the method according to the invention in detail.

In the Sole FIGURE, the sequence of the method according to the inventions is depicted schematically. A structure-borne sound signal can be generated, for example by the vehicle user, on the outer shell of the vehicle 1. The structure-borne sound signal can for example be a tapping signal with a specific signal pattern. The structure-borne sound signal generated is detected by at least one structure-borne sound sensor 2. Different signal patterns can be assigned to different functional devices of the vehicle. For example one specific signal pattern can be assigned to the drive device of the tailgate. The detected structure-borne sound signal is analysed in an evaluation device for the presence of a specific signal pattern 3. On detecting a specific signal pattern that is assigned to a specific functional device, a control signal can be sent, for example by a control unit, to the corresponding functional device 4. By generating 1 a specific structure-borne sound signal, in particular a set tapping sequence, and following the detection 2 of the structure-borne sound signal by a structure-borne sound sensor and the analysis 3 by an evaluation device, a functional device which is assigned that signal pattern can be started up 4.

All of the characteristics mentioned in the present description and in the claims can be combined with the characteristics of the independent claims as desired. The disclosure of the invention is thus not restricted to the described or claimed characteristic combinations, rather all characteristic combinations which make sense within the framework of the invention are to be considered as disclosed.

1. A method for activating at least one functional device of a vehicle,
wherein
at least one structure-borne sound signal effected by a vehicle user on the vehicle shell of the vehicle is detected with at least one structure-borne sound sensor,
the structure-borne sound signal is analysed by means of an evaluation device for the presence of a specific signal pattern,
a specific functional device of the vehicle is assigned to the signal pattern, and
on detecting the specific signal pattern a control signal is sent to the functional device which is assigned to the signal pattern.

2. The method according to claim 1, wherein the functional device is a drive device for a closure element of a vehicle opening, in particular a vehicle door and/or a vehicle window.

3. The method according to claim 2, wherein the functional device is at least one drive device of the front bonnet and/or the tailgate and/or the charge point cover and/or the fuel cap.

4. The method according to claim 2, wherein at least one structure-borne sound sensor is assigned to each closure element to be activated, that on the detection of a structure-borne sound signal by the assigned structure-borne sound sensor, a control signal is sent to the drive device of the closure element so that an at least partial opening or closing of the closure element is initiated.

5. The method according to claim 1, wherein a number of structure-borne sound sensors are assigned to one closure element.

6. The method according to claim 1, wherein,
a signal pattern that is assigned to a specific functional device of the vehicle can be individually determined.

7. The method according to claim 1, wherein,
the signal patterns of the detected structure-borne sound signals can be generated by a tapping sequence made by vehicle user on the outer shell of the vehicle.

8. The method according to claim 1, wherein,
the intensity and/or number and/or the chronological sequence of the tapping contacts in a structure-borne sound signal are detected in the evaluation device.

9. A vehicle with structure-borne sound conducting structure-borne sound sensors connected to the outer shell of the vehicle, with at least one evaluation device for evaluating structure-borne sound signals and with at least one control unit for activating at least one functional device of the vehicle,
wherein
the structure-borne sound sensors are designed to detect at least one structure-borne sound signal in the form of a tapping pattern on the outer shell of the vehicle,
the evaluation device is designed to analyse the detected structure-borne sound signal for the presence of at least one specific signal pattern, and
the evaluation device is connected in a signal-conducting manner for control purposes to at least one functional device of the vehicle via at least one control unit.

10. The vehicle according to claim 9, wherein at least one functional device is designed as a drive device for driving at least one closure device, in particular a vehicle door and/or a vehicle window, and that at least one structure-borne sound sensor is assigned to each closure device by a structure-borne sound conducting connection.
